(19) United States
(12) Patent Application Publication
(10) Pub. No.: US 2017/0327777 A1
(43) Pub. Date: Nov. 16, 2017

(54) COCKTAIL MIX TECHNOLOGY

(71) Applicant: Barmalade LLC, Dallas, TX (US)

(72) Inventor: Jorge Enrique Alvarez, Dallas, TX (US)

(21) Appl. No.: 15/591,782

(22) Filed: May 10, 2017

Related U.S. Application Data
(60) Provisional application No. 62/334,624, filed on May 11, 2016.

(51) Int. Cl. C12G 3/06

(52) U.S. Cl. CPC C12G 3/06

(57) ABSTRACT

The invention provides a cocktail mix composition that includes: (a) one or more fruits, herbs, spices, and/or vegetables, and (b) pectin. The cocktail mix composition has a viscosity of less than 250 centistokes.

### PRIORITY CLAIM

This application claims priority to U.S. provisional patent application No. 62/334,624 filed May 11, 2016, the contents of which are hereby incorporated by reference herein.

### FIELD OF THE INVENTION

The present invention relates generally to mixing cocktails. More particularly, this invention relates to a jam-based material for mixing cocktails.

### BACKGROUND OF THE INVENTION

Many upscale bars and restaurants serve hand-muddled fruit and herb cocktails. These drinks, while appealing in terms of their taste, often take so long to make that customers get irritated waiting for their drinks. In certain instances, jam has been mixed with spirit to make cocktails. The resulting drinks, however, tend to be too clumpy, with the jam often breaking apart in the drink and sinking to the bottom. More generally, these jam-based cocktails tend not to blend well with spirit.

It would be desirable to provide a cocktail mix composition that that is more soluble, tastes better than a hand-muddled cocktail, takes less time to make and costs less to make—less labor in regards to time, less ingredients and less spoilage of the typical fresh fruit/herbs/vegetables.

### SUMMARY OF THE INVENTION

Some embodiments of the invention provide a cocktail mix composition comprising: (a) one or more fruits, herbs, spices, and/or vegetables, and (b) pectin, the cocktail mix composition having a viscosity of less than 250 centistokes.

In certain embodiments, the invention provides a method of mixing a cocktail. The method involves mixing an alcohol-containing liquid (e.g., a spirit) together with a cocktail mix composition, without adding syrup, and the cocktail mix composition comprises: (a) one or more fruits, herbs, spices, and/or vegetables, and (b) pectin, the cocktail mix composition having a viscosity of less than 250 cntistokes.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

The present invention provides a premium cocktail mix (or “mixer”) composition, which preferably is all natural. For example, the cocktail mix composition preferably is devoid of artificial colors, added flavors, and chemical preservatives. It allows the user to make a five-star restaurant quality cocktail without the hassle of hand-muddling ingredients. It preferably requires only a few easy steps to make a phenomenal cocktail: add the mix, spirit, (e.g., an alcohol-containing liquid), ice, and optionally a squeeze of lemon, lime, or both, then shake. The cocktail mixing method preferably is devoid of adding a syrup (i.e., the mixing method preferably involves adding no simple syrup).

The cocktail mix composition is made using a jamming process. Water is blended with one or more fruits, herbs, spices, and/or vegetables to create the unique flavor combinations. Preferably, at least one fruit is used. The ingredients are brought to a boil, at which point sugar, citric acid, and pectin are added. Surprisingly small amounts of pectin are used. From the point of boiling, all ingredients preferably are whisked together (e.g., in a pot) and then poured into jars (e.g., a glass jar) or other desired containers. When jars are used, a lid (e.g., a metal lid) is screwed onto (by hand or otherwise) each jar, after which each such jar is flipped upside down. The heat inversion method is used for sealing. The jar, for example, can be a generally cylindrical jar with a generally circular metal lid that is internally threaded to match external threads on the top of the jar.

In many cases, the cocktail mix composition includes at least one fruit, at least one vegetable, or both. Preferably, the cocktail mix includes at least one fruit. This can be the case in any embodiment of the present disclosure. In some cases, the cocktail mix composition includes seeds (e.g., fruit seeds), preferably together with juice (e.g., fruit juice). For example, the cocktail mix composition can include seeds and pulp, or seeds and flesh (e.g., fruit seeds and fruit pulp, or fruit seeds and fruit flesh), preferably together with juice (e.g., fruit juice). In any such cases, the composition can further include skin (e.g., fruit skin). Thus, it can be appreciated that the present cocktail mix composition is a jamming composition in the it includes such components of one or more fruits, herbs, spices, and/or vegetables, as well as pectin.

Preferably, the pectin level in the present cocktail mix composition is particularly low. For example, in terms of a volume percentage (i.e., the volume of pectin divided by the total volume of the mix), the pectin preferably is provided at less than 1%, more preferably less than 0.75%, and perhaps optimally less than 0.5%. In addition, there preferably is at least 0.005% pectin, and perhaps more preferably at least 0.075% pectin, such as from 0.01% to 0.45% pectin. In certain examples, the volume percentage of pectin in the cocktail mix composition is in the range of about 0.014-0.32%. As one non-limiting example, if a 32 fluid ounce jar is filled with the present mix, there preferably is less than 0.32 fluid ounce of pectin, such as about 0.098 fluid ounce of pectin or less (giving a pectin volume percentage of about 0.3% or less). As another non-limiting example, if a 16 fluid ounce jar is filled with the present mix, there preferably is less than 0.16 fluid ounce of pectin, such as about 0.049 fluid ounce of pectin or less (again, giving a pectin volume percentage of about 0.3% or less). The present ounce measurements are based on the United States customary fluid ounce. The pectin content for any embodiment of the present disclosure can optionally be within any one or more ranges noted in this paragraph.

The water content in the present cocktail mix composition can optionally be less than 50% (on a volume basis). This can optionally be the case in any embodiment of the present disclosure. Preferably, the water content is in the range of from 5-40 percent, such as from 5-35%, and perhaps optimally from 10-30%.

The pectin acts as the binding agent, and it gives the resulting mix a consistency that enables the mix to be poured. Due to the very low levels of pectin, the viscosity is thin, yet still binding. The viscosity is much lower than (i.e., it is much thinner than) conventional jams, jellies, preserves, and marmalades. Yet the viscosity is higher than conventional syrups.

The present cocktail mix composition preferably has a viscosity that facilitates pouring nicely and blending well with alcohol. For example, the viscosity of the mix preferably is less than 300 centistokes, and more preferably is less than 250 centistokes, such as 240 centistokes or less. In addition, the viscosity preferably is greater than 5 centistokes, greater than 20 centistokes, or even greater than 40 centistokes. In some cases, the viscosity of the mix is from 40-250 centistokes, such as in the range of 51-231 centistokes. In one group of embodiments, the viscosity is from 40-150, such as from 45-100. In another group of embodiments, the viscosity of the mix is from 151-250 centistokes, such as in the range of 155-245 centistokes. In certain embodiments, the viscosity is from 90-190, such as from 100-180. Any embodiment of the present disclosure can optionally have a viscosity in any one or more of the ranges noted in this paragraph.

In certain embodiments, the present pectin-containing cocktail mix composition has a particularly thin composition, and thus a particularly low viscosity. In these embodiments, the cocktail mix composition may have a viscosity in the range of from 5-240 centistokes, such as from 5-150 centistokes, or from 5-100 centistokes, or even from 5-75 centistokes. The cocktail mix composition viscosity for any embodiment of the present disclosure can optionally be within any one or more ranges noted in this paragraph or the previous paragraph.

The foregoing viscosity ranges are based on testing with a Zahn viscosimeter (viscosity cup)—Stainless Steel Cup #2 (or “B”). This is part number 08700-61 from Cole-Parmer. The orifice diameter is 2.74 mm (0.108 in). Each sample is 77 degrees F. when tested. This is calculated using Zahn seconds, which for our products is a range of 28-80 Zahn seconds. The formula used is V=3.5 (T−14). “T” is the seconds it takes for the product to flow through the cup to empty. The following methodology is used: 14 oz glass with 2 inch diameter is filled with 7 ounces of the mix, viscosimeter is placed in glass along with thermometer, once 77 degrees is achieved, the thermometer is removed, finger is placed in ring on viscosimeter, lifted completely out of the liquid and started the stop watch when the top edge of the cup broke the surface, holding the bottom of the cup 4.5 inches above surface, the watch is stopped when the cup emptied. The viscosimeter and all utensils are cleaned and dried with a soft, lint-free towel between testing of the different flavors.

The present cocktail mix composition can be used to make great tasting alcoholic and non-alcoholic beverages in just a few easy steps. For bar/restaurant owners, they save money on ingredients and shrinkage of ingredients. They also save money on the preparation time, given the types of ingredients that are typically used to make similar cocktails. The present mix allows bar/restaurant owners to make the cocktails faster, so they can serve them faster and sell more cocktails, thus increasing sales and profits. For home use, the present mix does the same thing, i.e., it saves the consumer time and money. Consumers save money by not having to buy fresh ingredients, not having to process fruit and/or vegetables themselves, and not having to go through the usual arduous steps of creating a hand-muddled fruit and herb cocktail.

The present cocktail mix composition also requires a particular small amount of product compared to commercially available cocktail mixers for fruit and herb cocktails (traditional cocktail mixers typically take at least three times the amount of our product to make a cocktail).

Moreover, the present cocktail mix composition provides a particularly advantageous shelf life. This is realized from the process used to make it. In more detail, the mix has an opened, refrigerated shelf-life of 60 days, and an un-opened shelf life of 1 year. While the mix can be used quite advantageously for mixing alcohol-based cocktails, it can also be mixed with non-alcoholic beverages, used on foods, etc.

The invention also provides methods of mixing a cocktail using the present cocktail mix composition. The method involves mixing an alcohol-containing, liquid (e.g., a spirit) together with a cocktail mix composition, preferably without adding syrup, where the cocktail mix composition includes: (a) one or more fruits, herbs, spices, and/or vegetables, and (b) pectin the cocktail mix composition having a viscosity of less than 250 centistikes. A wide variety of alcohol-containing liquids can be used, such as vodka, rum, gin, bourbon, and/or tequila. Thus, in certain embodiments, the alcohol-containing liquid is selected from the group consisting of vodka, rum, gin, bourbon, and tequila. Combinations of two or more of these spirits can also be used.

The cocktail mix makes preparing an all-natural cocktail easier than ever before. As noted above, the cocktail mix composition preferably is devoid of artificial colors, added flavors, and chemical preservatives. Thus, the mixing method preferably is, for example devoid of any step that involves adding artificial colors. Simply add the specified amount of 1.5 ounces of the mix or less to the specified amount of 2 ounces or less of desired spirit. Add the squeeze of one wedge of lemon or lime. Add ice, shake and serve.

In certain embodiments, the present cocktail mix composition consists of (a) fruit, herbs, spice, and/or vegetables, (b) pectin, (c) sugar, and (d) citric acid.

Following are two non-limiting example recipes for two flavors:

1) Grapefruit-Elderflower mix composition, 32 oz jar: 25.25 ounces of grapefruit, 1.5 ounces of elderflower extract, 16.1 ounces of pure cane sugar, 7.25 ounces of filtered water, 0.1667 ounces of citric acid, 0.09891 ounces of all-natural pectin, and

2) Mango-Habanero mix composition: 28 ounces of mango, 0.55 ounces of habanero peppers, 16.005 ounces of sugar, 18 ounces of filtered water, 0.1667 ounces of citric acid, 0.5 ounces of calcium water, 0.0052 ounces of all-natural pectin.

While some preferred embodiments of the invention have been described, it should be understood that various changes, adaptations and modifications may be made therein without departing from the spirit of the invention and the scope of the appended claims.

What is claimed is:

1. A cocktail mix composition comprising: (a) one or more fruits, herbs, spices, and/or vegetables, and (b) pectin, the cocktail mix composition having a viscosity of less than 250 centistokes.

2. The cocktail mix composition of claim 1 wherein the cocktail mix includes fruit.

3. The cocktail mix composition of claim 1 further comprising: (c) sugar, and (d) citric acid.

4. The cocktail mix composition of claim 1 wherein the cocktail mix consists of (a) fruit, herbs, spice, and/or vegetables, (b) pectin, (c) sugar, and (d) citric acid.

5. The cocktail mix composition of claim 1 wherein the viscosity is greater than 20 centistokes.

6. The cocktail mix composition of claim 5 wherein the viscosity is the range of 51-231 centistokes.

7. The cocktail mix composition of claim 1 wherein the pectin is present at a volume percentage of less than 1%.

8. The cocktail mix composition of claim 7 wherein the volume percentage of the pectin is less than 0.5%.

9. The cocktail mix composition of claim 8 wherein the volume percentage of the pectin is at least 0.05%.

10. The cocktail mix composition of claim 9 wherein the volume percentage of the pectin is from 0.01% to 0.45% pectin.

11. The cocktail mix composition of claim 1 wherein the cocktail mix composition has a water content of less than 50%.

12. The cocktail mix composition of claim 11 wherein the water content of the cocktail mix composition is in the range of 5-40%.

13. The cocktail mix composition of claim 1 wherein the cocktail mix composition is packaged inside a jar.

14. The cocktail mix composition of claim 1 wherein the one or more fruits, herbs, spices, and/or vegetables comprises seeds.

15. The cocktail mix composition of claim 14 wherein the one or more fruits, herbs, spices, and/or vegetables comprises juice.

16. The cocktail mix composition of claim 14 wherein the one or more fruits, herbs, spices, and/or vegetables comprises seeds and pulp or seeds and flesh.

17. The cocktail mix composition of claim 14 wherein the one or more fruits, herbs, spices, and/or vegetables comprises skin.

18. The cocktail mix composition of claim 1 wherein the one or more fruits, herbs, spices, and/or vegetables comprises juice, seeds, and pulp

19. The cocktail mix composition of claim 1 wherein the one or more fruits, herbs, spices, and/or vegetables comprises juice, seeds, pulp, and skin

20. A method of mixing a cocktail, the method comprising mixing an alcohol-containing liquid together with a cocktail mix composition, without adding syrup, the cocktail mix composition comprising: (a) one or more fruits, herbs, spices, and/or vegetables, and (b) pectin, the cocktail mix composition having a viscosity of less than 250 centistokes.
